(19) United States
(12) Patent Application Publication
(10) Pub. No.: US 2010/0124052 A1
(43) Pub. Date: May 20, 2010

(54) LED LAMP BAR

(76) Inventor: Qing-Lu YU, Taichung County (TW)

Correspondence Address: JAW-HWA, 10-1, No. 23, Sec. 1, Chang-An E. Rd., Taipei City, omitted

(21) Appl. No.: 12/272,847

(22) Filed: Nov. 18, 2008

(51) Int. Cl. F21V 1/00

(52) U.S. Cl. 362/217.02

(57) ABSTRACT

The present invention discloses an LED lamp bar, which mounts a plurality of LEDs and comprises an extruded aluminum reflection back plate, at least one LED carrier plate, at least one driver, a transparent lamp cover, and two side plates. The LED carrier plate and driver are arranged on the extruded aluminum reflection back plate. The LED carrier plate mounts the LEDs. The driver is coupled to the LED carrier plate and drives the LEDs. The transparent lamp cover and two side plates are installed on the extruded aluminum reflection back plate to encase the LED carrier plate and driver. The extruded aluminum reflection back plate features high reflectivity and high thermal conductivity can promote light efficiency and dissipate heat fast, wherefore the present invention is exempted from burnout caused by high temperature.

### FIELD OF THE INVENTION

The present invention relates to an LED, particularly to an LED lamp bar.

### BACKGROUND OF THE INVENTION

LED is a new-generation illumination element and features high energy efficiency and high light efficiency. LED has been widely used in various illumination devices. However, a single LED is hard to parallel a traditional fluorescent lamp or halogen lamp in brightness. Therefore, LEDs are usually assembled together to provide sufficient brightness.

A single LED generates limited heat, but an LED assembly generates considerable heat. A great amount of heat is apt to result in high temperature, and high temperature deteriorates and disables LED soon. Therefore, an LED illuminator needs a special cooler, such as an electric fan to dissipate heat. However, an electric fan increases cost and generates noise, which impairs the popularization of LED lamps.

### SUMMARY OF THE INVENTION

The primary objective of the present invention is to provide an easy-to-fabricate LED assembly for daily illumination.

To achieve the abovementioned objective, the present invention proposes an LED lamp bar, which comprises an extruded aluminum reflection back plate, at least one LED carrier plate, at least one driver, a transparent lamp cover, and two side plates. The extruded aluminum reflection back plate is a strip-like structure having an accommodation room. The LED carrier plate is arranged in the accommodation room and has a plurality of contacts respectively mounting a plurality of LEDs. The driver is coupled to the LED carrier plate and drives a plurality of LEDs to emit light. The transparent lamp cover is installed on the extruded aluminum reflection back plate and covers the accommodation room. The two side plates are also installed on the extruded aluminum reflection back plate and cooperate with the transparent lamp cover to encase the accommodation room.

The present invention assembles together a plurality of LEDs to supply daily illumination. The extruded aluminum reflection back plate featuring high reflectivity and high thermal conductivity promotes light efficiency and dissipates heat fast, wherefore the present invention is exempted from high temperature and will satisfy consumers.

### BRIEF DESCRIPTION OF THE DRAWINGS

FIG. 1 is an exploded view schematically showing the structure of an LED lamp bar according to one embodiment of the present invention;

FIG. 2 is a diagram schematically showing the assembled structure of an LED lamp bar according to one embodiment of the present invention;

FIG. 3 is a diagram schematically showing the installation of a power source in an LED lamp bar according to one embodiment of the present invention; and

FIG. 4 is a diagram schematically showing the assembled structure of an LED lamp bar according to another embodiment of the present invention.

### DETAILED DESCRIPTION OF THE PREFERRED EMBODIMENTS

Below, the embodiments are described in detail to demonstrate the technical contents of the present invention. However, the embodiments are only to exemplify the present invention but not to limit the scope of the present invention.

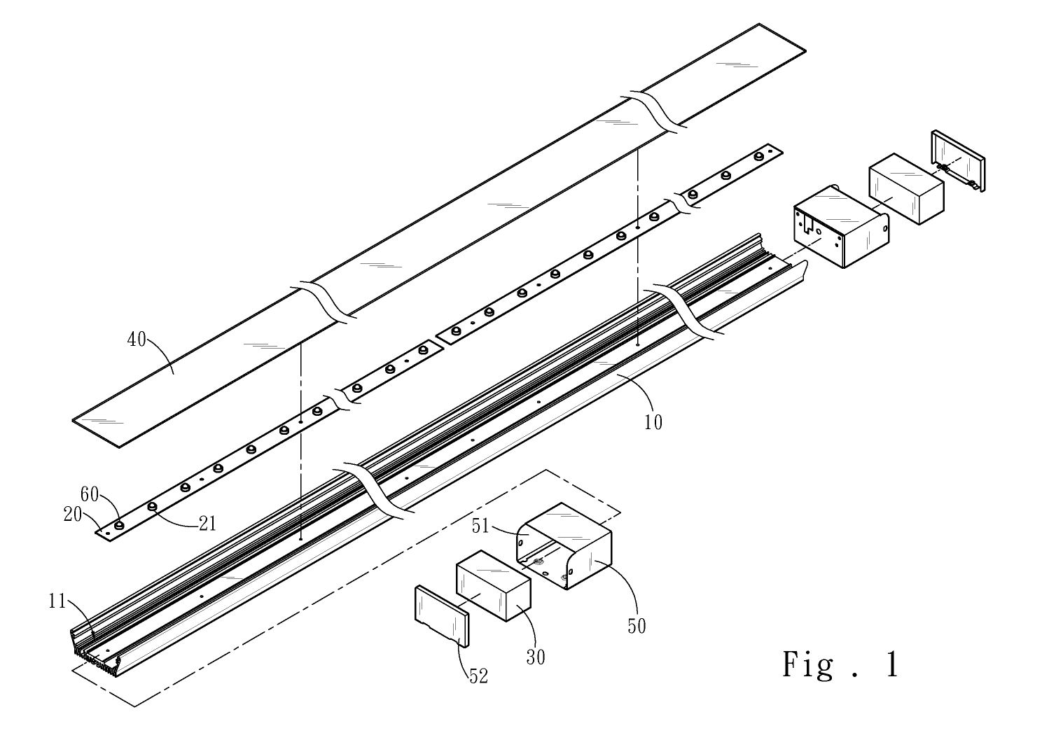

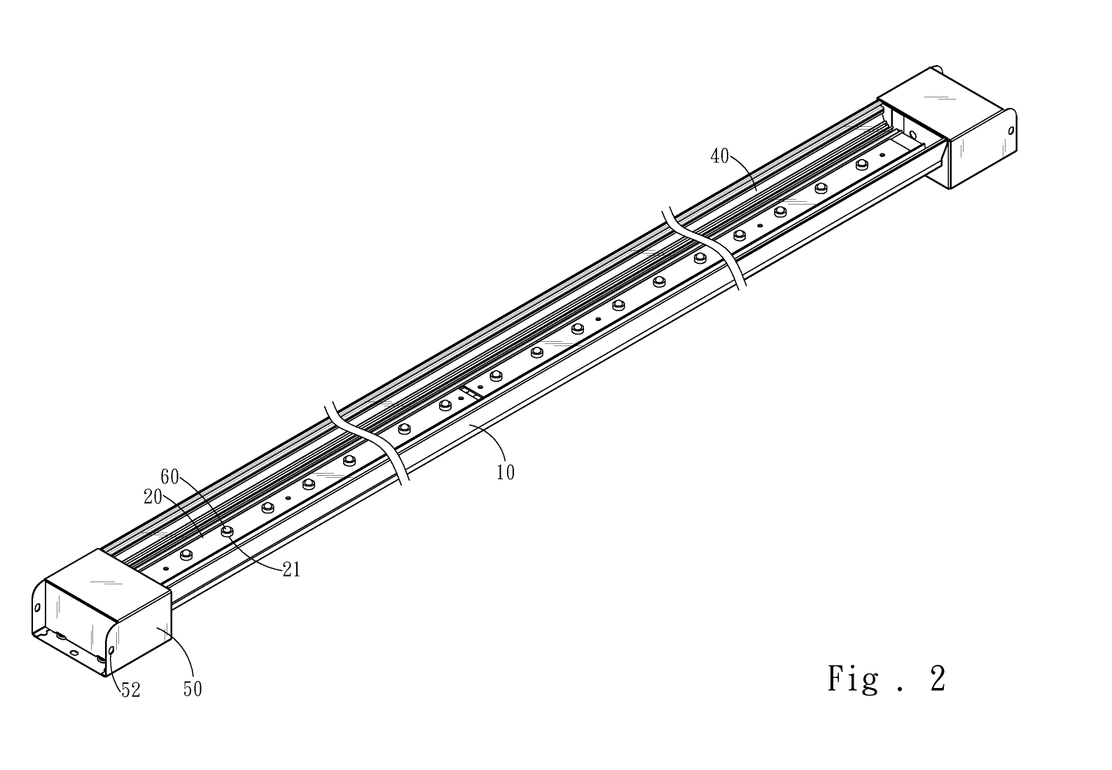

Refer to FIG. 1 and FIG. 2. The LED lamp bar of the present invention comprises an extruded aluminum reflection back plate 10, at least one LED carrier plate 20, at least one driver 30, a transparent lamp cover 40, and two side plates 50. The LED lamp bar mounts a plurality of LEDs 60. The extruded aluminum reflection back plate 10 is a strip-like structure having an accommodation room 11. The LED carrier plate 20 is arranged in the accommodation room 11 and has a plurality of contacts 21. The contacts 21 are preferably arranged into a line or lines. A plurality of contacts 21 respectively mounts a plurality of LEDs 60.

The driver 30 is coupled to the LED carrier plate 20 and supply voltage to drive a plurality of LEDs 60 to emit light. The transparent lamp cover 40 is installed on the extruded aluminum reflection back plate 10 and covers the accommodation room 11. The transparent lamp cover 40 allows the light emitted by the LEDs 60 to pass through and uniformly scatters the light. The two side plates 50 are also installed on the extruded aluminum reflection back plate 10 and cooperate with the transparent lamp cover 40 to encase the accommodation room 11 and protect a plurality of LEDs 60 and the driver 30.

The side plate 50 has an accommodation room 51 accommodating the driver 30. The side plate 50 also has a blocking cover 52 used to close the accommodation room 51 and protect the driver 30.

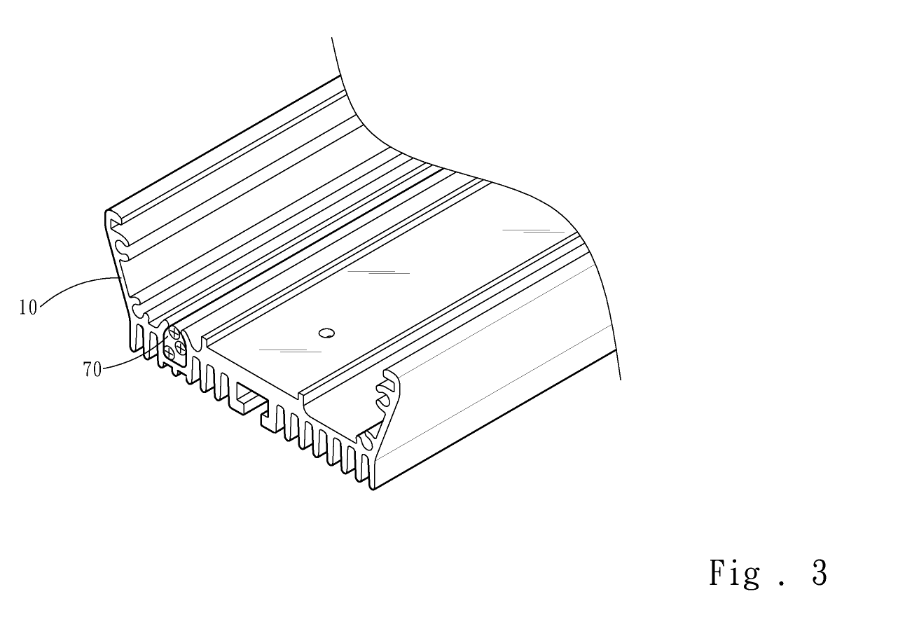

Refer to FIG. 3. A power source 70 is embedded on the extruded aluminum reflection back plate 10 and connected to the driver 30 and supplying power to the driver 30.

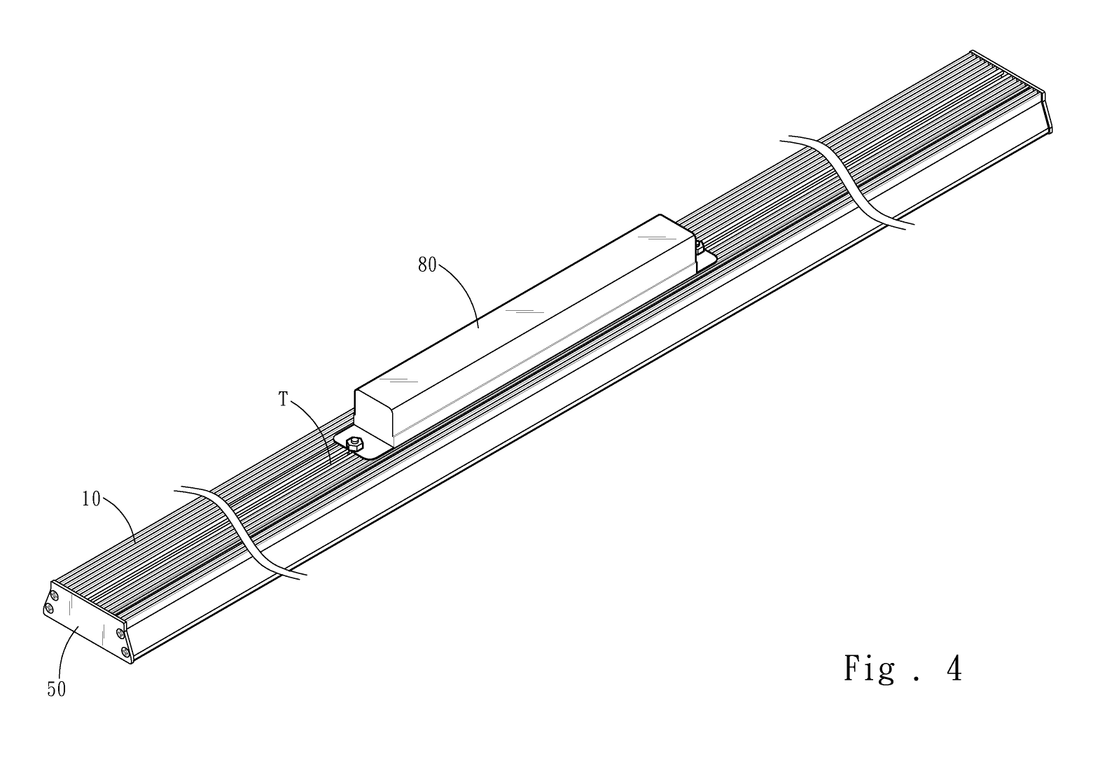

Refer to FIG. 4 for another embodiment of the present invention. In this embodiment, a slot T is formed on one plane of the extruded aluminum reflection back plate 10, wherein the plane is far from the transparent lamp cover 40. A hood 80 is fixed to the plane via driving a screw (or another fastening element) through the hood 80 into the slot T. The hood 80 accommodates the power source 70 and the driver 30.

The structure of the present invention mounts a plurality of LEDs 60. The LEDs 60 are preferably but not limited to white-light LEDs. The LEDs assembled on the LED lamp bar of the present invention can generate light with sufficient brightness to afford daily illumination. The extruded aluminum reflection back plate 10 featuring high reflectivity and high thermal conductivity can promote light efficiency and dissipate heat fast, wherefore the present invention is exempted from high temperature, less likely to malfunction, has a longer service life, and will satisfy consumers.

What is claimed is:

1. A light-emitting-diode lamp bar, mounting a plurality of light emitting diodes (LED), and comprising:
an extruded aluminum reflection back plate being a strip-like structure and having an accommodation room;
at least one LED carrier plate arranged in said accommodation room and having a plurality of contacts respectively mounting said LEDs;
at least one driver coupled to said LED carrier plate and driving said LEDs to emit light;
a transparent lamp cover installed on said extruded aluminum reflection back plate and covering said accommodation room; and
two side plates installed on said extruded aluminum reflection back plate and cooperating with said transparent lamp cover to encase said accommodation room.

2. The light-emitting-diode lamp bar according to claim 1, wherein said side plate has an accommodation room accommodating said driver.

3. The light-emitting-diode lamp bar according to claim 2, wherein said side plate has a blocking cover used to close said accommodation room.

4. The light-emitting-diode lamp bar according to claim 1, wherein said contacts are arranged into a line or lines.

5. The light-emitting-diode lamp bar according to claim 1, wherein a power source is embedded on said extruded aluminum reflection back plate; said power source is connected to said driver and supplies power to said driver.

6. The light-emitting-diode lamp bar according to claim 5, wherein a hood is arranged on one plane of said extruded aluminum reflection back plate, wherein said plane is far from said transparent lamp cover; said hood accommodates said power source and said driver.
